(19) United States
(12) Patent Application Publication
(10) Pub. No.: US 2026/0333024 A1
(43) Pub. Date: Oct. 22, 2026

(54) CONTROLLING NETWORK BEHAVIOUR TO INHIBIT INFORMATION LEAKAGE

(71) Applicant: Nokia Technologies Oy, Espoo (FI)

(72) Inventors: John HARRIS, Whitefish Bay, WI (US); Daniela LASELVA, Klarup (DK); Roy YANG, Buffalo Grove, IL (US)

(73) Assignee: Nokia Technologies Oy, Espoo (FI)

(21) Appl. No.: 19/110,554

(22) PCT Filed: Aug. 23, 2023
(86) PCT No.: PCT/EP2023/073183

§ 371 Date: Mar. 11, 2025

(30) Foreign Application Priority Data
Sep. 13, 2022 (GB) 2213342.5

(51) Int. Cl. H04W 12/02; H04W 12/63; H04W 52/02

(52) U.S. Cl. CPC H04W 12/02; H04W 12/63; H04W 52/0216

(57) ABSTRACT

A network may have certain energy saving behaviours that risk leaking information regarding the location of a user equipment. A user equipment may generate and transmit privacy preference information that is relevant to network behaviour to the network. The network may then modify behaviour that it deems may leak information regarding the user equipment where the user equipment has indicated a desire for enhanced privacy.

### TECHNOLOGICAL FIELD

Various example embodiments relate to information leakage to third parties due to network behaviour in radio access technology networks such as by carrier or cell deactivation.

### BACKGROUND

Various energy saving techniques may be applied in a RAT (radio access technology) network. Such energy saving techniques may include putting some or all of the components of some network nodes into a low power mode, this may involve cell activation and deactivation. As energy saving techniques on the network side become more refined, information regarding the user equipment may unintentionally leak as a result. The activation/deactivation of a small cell for example may allow a third party to deduce information relevant to the location and/or trajectory of a mobile user and in this way the privacy of the UE may be compromised by energy saving techniques at the network side.

It would be desirable to be able to limit or at least provide some control of the information leaked.

### BRIEF SUMMARY

The scope of protection sought for various embodiments of the invention is set out by the independent claims. The examples and features, if any, described in this specification that do not fall under the scope of the independent claims are to be interpreted as examples useful for understanding various embodiments of the invention.

According to various, but not necessarily all, embodiments there is provided an apparatus comprising: generating circuitry configured to generate privacy preference information relevant to network behaviour for said apparatus; and a transmitter configured to transmit said privacy preference information towards a network node within a 3GPP communication network.

It was recognised that the behaviour of a network with respect to an apparatus such as a user equipment within the network may result in information regarding that apparatus leaking and becoming inadvertently available to third parties. There may be occasions where this leakage of information is particularly undesirable. This has been addressed by providing circuitry configured to generate privacy preference information that is relevant to network behaviour and to transmit this to a network node within a 3GPP communication network.

This provides the network with information regarding circumstances where it may be desirable to modify any behaviour that my leak information regarding that apparatus.

The network behaviour may be any network behaviour where information regarding the location of the apparatus may leak, that is inadvertently become available to third parties. This may include network energy saving behaviour including the activation and deactivation of network nodes or of carriers within the network nodes as the apparatus moves into and out of cells or requests service from cells that these network nodes support radio coverage within.

In some example embodiments, said privacy preference information comprises a plurality of privacy preferences, at least one of said plurality of preferences being relative to at least one of the following: activity of said apparatus; location of said apparatus; or time.

The privacy preference information may simply include an indication that enhanced privacy is desired. Alternatively, it may comprise a plurality of privacy preferences at least one of which is relevant to an activity of the apparatus, its location and/or a time. The privacy preference information may simply indicate enhanced privacy is required or it may indicate a level of privacy desired. It may be related to one or more locations, one or more time periods or one or more activities performed by the apparatus.

In some embodiments, said privacy preference information comprises a plurality of privacy preferences, relative to a plurality of the following: activity of said apparatus; location of said apparatus; or time.

Although the privacy preference information may be transmitted towards a network node in a number of forms, in some example embodiments, said apparatus comprises a user equipment and said user equipment is configured to generate and transmit said privacy preference information to the network as part of UEAssistanceInformation, an RRC (radio resource control) message, and/or a MAC (medium access control) Control Element (CE).

In some example embodiments, said apparatus comprises a user interface configured to display a request for privacy preference to a user and to receive input from said user; said generating circuitry being configured to generate said privacy preference information in response to said user input.

In some example embodiments, said user interface is configured to display a request for a plurality of privacy preferences relative to at least one of the following: activity of said apparatus; location of said apparatus; or time.

In some example embodiments, said network node comprises a serving network node supporting providing radio coverage in a cell.

In some example embodiments, the cell may be a capacity cell and in some example embodiments it may be a coverage cell.

In some example embodiments, said apparatus further comprises circuitry configured to determine a requirement for enhanced privacy; said circuitry for generating and said transmitter being configured to generate and transmit said privacy preference information in response to said determining circuitry determining said requirement for enhanced privacy.

According to various, but not necessarily all embodiments, there is provided an apparatus comprising: control circuitry configured in response to receiving privacy preference information indicating a preference for enhanced privacy of a user equipment to modify a behaviour of said apparatus.

In some example embodiments, said apparatus comprises a receiver for receiving said privacy preference information.

In some example embodiments, said apparatus comprises energy saving circuitry configured to control said apparatus to reduce energy consumption by performing energy saving behaviour, said control circuitry being responsive to receipt of said privacy preference information indicating said preference for enhanced privacy of said user equipment to control said energy saving circuitry to modify said behaviour of said apparatus with respect to said user equipment.

In some example embodiments, said apparatus comprises a network node configured to support radio coverage in a cell; said network node comprising a data store for storing said privacy preference information for said user equipment; wherein said energy saving circuitry is configured to reduce energy consumption of said apparatus when determining loading by user equipment in said cell is low and to increase energy consumption on detecting an increase or potential increase in loading from user equipment, said energy saving circuitry being configured to modify said energy saving behaviour by delaying increasing said energy consumption on detecting an increase or potential increase in loading from a user equipment for which privacy preference information indicating enhanced privacy has been received.

In some example embodiments, said privacy preference information comprises an indication of a time during which enhanced privacy of said user equipment is required, said control circuitry being configured to modify said behaviour of said apparatus with respect to said user equipment during said time indicated, and not to modify said behaviour with respect to said user equipment during other times.

In some example embodiments, said privacy preference information comprises an indication of at least one activity of said user equipment which when performed requires enhanced privacy, said control circuitry being configured to modify said behaviour of said apparatus with respect to said user equipment when said activity is performed and not to modify said behaviour when said activity is not performed.

In some example embodiments, said apparatus comprises a network node configured to support providing radio coverage in a cell, said apparatus further comprises: a receiver configured to receive said privacy preference information from a user equipment.

In some example embodiments, said apparatus comprises a network node configured to support providing radio coverage in a cell, said apparatus further comprises: a receiver configured to receive said privacy preference information from a network node within a 3GPP communication network.

In some example embodiments, said control circuitry is configured prior to modifying said behaviour to determine whether said apparatus is likely to perform steps that might leak information regarding said user equipment and where so to control said apparatus to modify said behaviour.

In some example embodiments, said control circuitry is configured in response to determining that said apparatus is not likely to perform steps that might leak information (e.g. during high load intervals where the network will not trigger energy saving features that may compromise privacy regardless of privacy preferences) to generate and transmit an indication to said user equipment requesting that said user equipment does not transmit privacy preference information.

In some example embodiments, said indication to said user equipment may comprise an indication of at least one of the following: a predetermined time or a predetermined location where said user equipment should not transmit said privacy preference information.

In some example embodiments, said indication to said user equipment may be transmitted as a signal to a group of user equipment.

According to various, but not necessarily all, embodiments there is provided a method comprising: generating privacy preference information relevant to network behaviour for an apparatus; and transmitting said privacy preference information towards a network node within a 3GPP network.

In some example embodiments said method further comprises displaying a request for privacy preference to a user; receiving a user input and generating said privacy preference information in response to said user input.

In some example embodiments, said method further comprises determining a requirement for enhanced privacy; and in response to determining said requirement for enhanced privacy generating and transmitting said privacy preference information.

According to various, but not necessarily all, embodiments there is provided a computer program comprising instructions which when executed by at least one processor on an apparatus cause the apparatus at least to perform the following steps: generating privacy preference information relevant to network behaviour for an apparatus; and transmitting said privacy preference information towards a network node within a 3GPP network.

According to various, but not necessarily all, embodiments there is provided an apparatus, comprising: at least one processor; and at least one memory storing instructions that when executed by the at least one processor cause the apparatus at least to perform: generating privacy preference information relevant to network behaviour for an apparatus; and transmitting said privacy preference information towards a network node within a 3GPP network.

According to various, but not necessarily all, embodiments there is provided an apparatus comprising: means for generating privacy preference information relevant to network behaviour for said apparatus; and means for transmitting said privacy preference information towards a network node within a 3GPP communication network.

In some example embodiments, said determining circuitry configured to determine a requirement for enhanced privacy comprises a means for determining a requirement for enhanced privacy.

In some example embodiments, said user interface comprises a means for displaying information and a means for receiving a user input.

According to various, but not necessarily all, embodiments there is provided an apparatus comprising: control means for modifying a behaviour of said apparatus in response to receiving privacy preference information indicating a preference for enhanced privacy of a user equipment.

In some example embodiments, said data store comprises a means for storing.

In some example embodiments, said energy saving circuitry comprises means for reducing energy consumption of said apparatus.

According to various, but not necessarily all, embodiments there is provided a method comprising: receiving privacy preference information indicating a preference for enhanced privacy of a user equipment; and in response to said information modifying said behaviour of said apparatus.

In some example embodiments, said step of modifying said behaviour of said apparatus comprises modifying energy saving behaviour of said apparatus in response to receipt of said privacy preference information indicating a preference for enhanced privacy of said user equipment.

In some example embodiments, said method is performed on a network node configured to support radio coverage in a cell; said method further comprising storing said privacy preference information for said user equipment within a data store; and reducing energy consumption of said apparatus when determining loading by said user equipment in said cell is low and increasing energy consumption on detecting an increase or potential increase in loading from said user equipment, said behaviour being modified by delaying increasing said energy consumption on detecting an increase or potential increase in loading from a user equipment for which privacy preference information indicating enhanced privacy has been received.

In some example embodiments, said privacy preference information comprises an indication of a time during which enhanced privacy of said user equipment is required, said step of modifying said behaviour of said apparatus with respect to said user equipment being performed during said time indicated and not during other time.

In some example embodiments, said privacy preference information comprises an indication of at least one activity of said user equipment which when performed does not require enhanced privacy, the step of modifying said behaviour of said apparatus with respect to said user equipment being performed when said activity is not being performed and not being performed when said activity is performed.

In some example embodiments, said method further comprises receiving said privacy preference information from a user equipment.

In other example embodiments, said method comprises receiving said privacy preference information from a network node within said 3GPP network.

According to various, but not necessarily all, embodiments there is provided a computer program comprising instructions which when executed by at least one processor on an apparatus cause the apparatus at least to perform at least: receiving privacy preference information indicating a preference for enhanced privacy of a user equipment; and in response to said information modifying a behaviour of said apparatus.

According to various, but not necessarily all, embodiments there is provided an apparatus comprising: at least one processor; and at least one memory storing instructions that when executed by the at least one processor cause the apparatus at least to perform: receiving privacy preference information indicating a preference for enhanced privacy of a user equipment; and modifying a behaviour of said apparatus

According to various, but not necessarily all, embodiments there is provided a non-transitory computer readable medium comprising program instructions stored thereon for performing at least the following:
generating privacy preference relevant to network behaviour information; and
forwarding said information for transmission towards a network node within a 3GPP communication network.

According to various, but not necessarily all, embodiments there is provided a non-transitory computer readable medium comprising program instructions stored thereon for performing at least the following:
in response to receipt of privacy preference information indicating a preference for enhanced privacy of a user equipment generating control signals to modify a behaviour of a network node.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

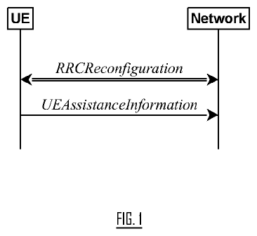

FIG. 1 illustrates an example signal flow between a user equipment and network;

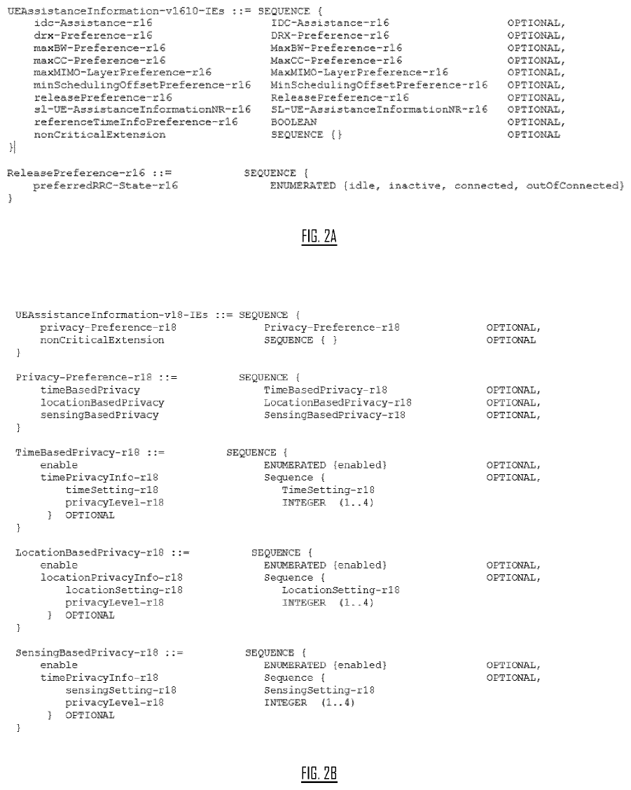

FIG. 2A and B schematically illustrate examples of UE assistance information signalling according to an example embodiment;

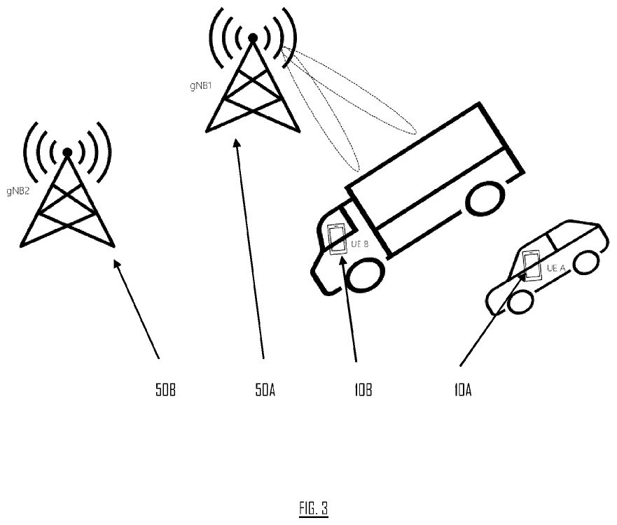

FIG. 3 shows an example of RF sensing in a wireless system

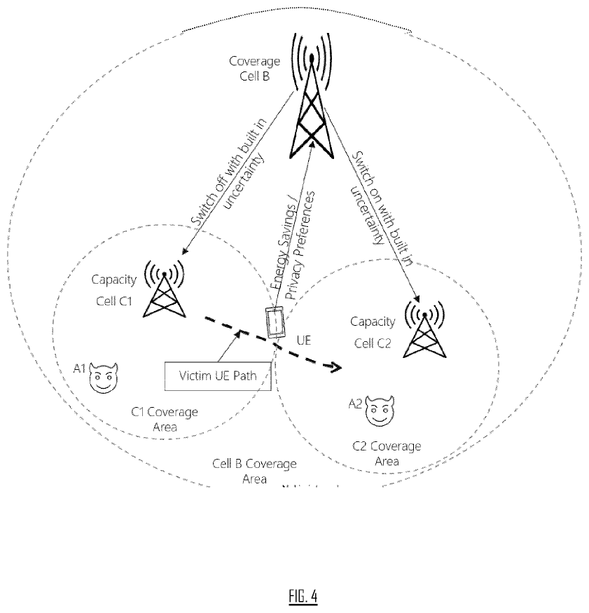

FIG. 4 illustrates how network behaviour may provide leakage of information regarding a user equipment's location;

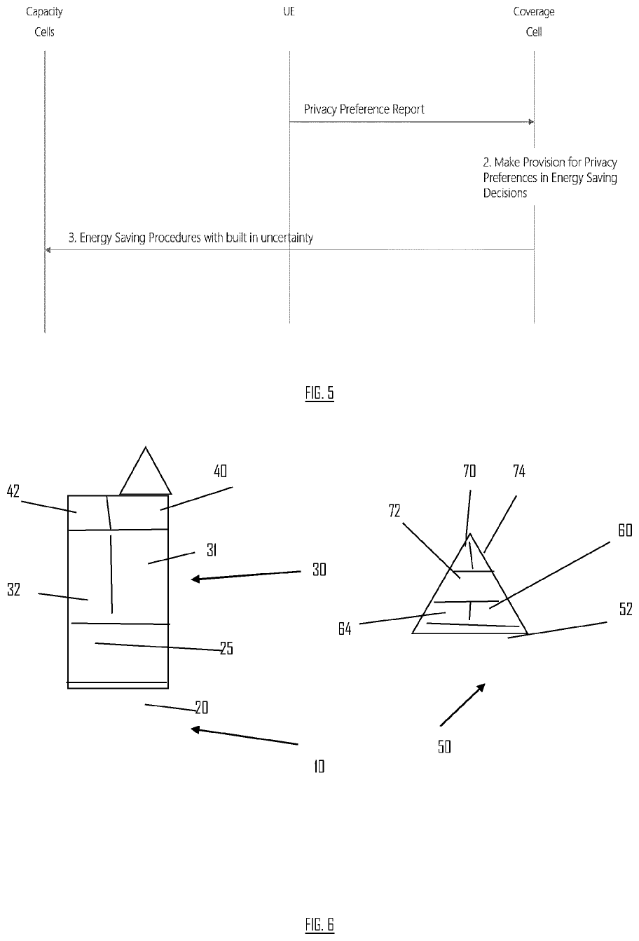

FIG. 5 illustrates signalling according to an example embodiment;

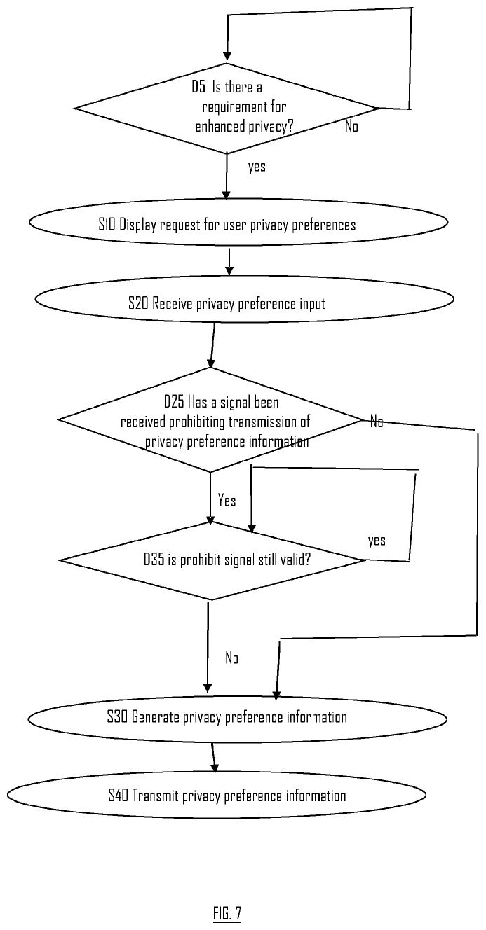

FIG. 6 schematically illustrate a user equipment and network node according to an example embodiment;

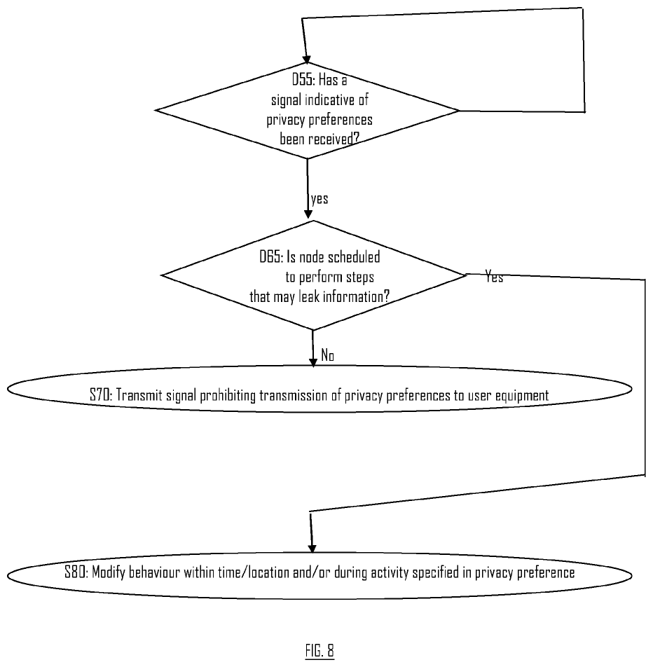

FIG. 7 schematically illustrates a flow diagram illustrating steps in a method performed at a user equipment according to an example embodiment; and

FIG. 8 schematically illustrates a flow diagram illustrating steps in a method performed at a network node according to an example embodiment.

### DETAILED DESCRIPTION

Before discussing the example embodiments in any more detail, first an overview will be provided.

Various ways of saving energy in a network NW are currently considered and energy saving can be achieved using the following:
Infrequent Synchronization Signal Block (SSB) transmission, e.g., using SSB periodicity of 160 ms could be considered in empty/low load situation in 5G NSA deployments
Discontinuous transmission (DTX) technique is a promising solution to save network energy by switching on/off radio units (e.g., power amplifier) when there is no transmission to be made.
Further components could be shut down, such as transmit antenna elements and corresponding baseband circuity.
Carrier or cell switch OFF (i.e., cell shutdown), which allows to switch off most of the hardware components of a cell, a frequency layer, or a RAN site.

One potential disadvantage of some of the NW energy saving procedures is that they may impact the behaviour of the UE and they may leak information to third parties regarding the UE's location.

3GPP has specified a set of power saving parameters for the UE in the UE-NR-Capability IE, one of which is the UEAssistanceInformation. The UEAssistanceInformation can be requested and retrieved by the gNB through RRC (radio resource control) signalling, as shown in FIG. 1.

The UEAssistanceInformation may contain various preference settings (carrier frequency list, DRX, bandwidth, number of component carriers, number of layers, scheduling latency, preferredRRC-state, etc.). The network node gNB may takes these preferences into account when it determines the optimal energy saving solutions that caters to the UE.

In some example embodiments, the UE may provide additional information in some cases with the UEAssistanceInformation, the additional information being indicative of the privacy requirements of the user equipment. This may be in the form of a single bit indicating if privacy is important or not, or it may be several bits, indicating the level of importance, or perhaps providing further details such as the locations where privacy is important, or the times that it is important. Alternatively and/or additionally the level of privacy may be linked to activities, performance or current operational conditions of the UE.

These privacy preferences are generated in recognition of the fact that some energy saving techniques or indeed other behaviour of the network node may leak information regarding the UE.

Enhanced energy efficiency of wireless networks can be obtained by cell deactivation, which allows the amount of energy expended by a RAN (radio access network) site/gNB to be reduced. This includes normal gNBs, and possibly closed subscriber group (CSG) cells like femto cells e.g. in someone's home. The problem is that with power saving change in the network, the sequence of energy saving actions may be observable by a third party (e.g. an ill-intentioned devices), and the observed sequence of energy saving actions thus may too closely match/mirror the UE so that it effectively “leaks” victim UE (or a group of e.g. affiliated UEs) positional information to e.g. an adversary(ies).

The conventional cell sleep mode (CSM) approach of transitioning cells in/out of cell sleep mode may, in certain cases/contexts, “leak” too much information on “likely” subscriber location/activity.

This leaking is enabled as any UE/end subscriber can monitor for what cells are present in the area, and thereby note when cells go in/out of cell sleep mode (that is visible from SSB/SIB1 synchronisation signal block/system information block pattern etc). For example, there can be devices/apps/software which perform monitoring of the cells availability/presence through scanner/sniffer/analyzer type of equipment's.

Malicious devices may detect the likely location/activity at that location by monitoring for changes in cell sleep mode. For example, when a UE or group of UEs arrive at a particular location, it may be that this will typically result in a cell at that location exiting its cell sleep mode. Potentially, some adversary (e.g. via apps and/or devices from some third-party, possibly powered by AI artificial intelligence) could monitor such observations of this cell sleep mode change and use them to detect the likely arrival of the UE(s) at that location. The opposite behaviour might also apply, where when the UE leaves (or UEs leave) an area, the local cell in that area may then enter cell sleep mode such that some adversary (e.g. via apps and/or devices from some 3rd party) can observe when that cell enters cell sleep mode to infer that the given UE(s) has/have likely left the area.

There are many possible example cases/scenarios, but below are just a few non-limiting examples.

### Arrival and then Departure Scenario Examples

When the network loading is relatively low (e.g. in the middle of the night, or in entertainment district during a weekday, or etc.) such that (capacity) cells are in an energy efficient/cell sleep mode.

Or in a more suburban or rural area, the hotspot/capacity/performance cells (e.g. enabling remote working) are more generally in cell sleep mode, except when people are home.

One or more UEs (e.g. public safety UEs, or a normal UE) arrive in these non-limiting example cell coverage locations causing that cell to exit the energy-efficient/cell sleep mode. This enables network energy savings prior to that activation and UEs that are in that cell location to e.g. communicate with higher data rate and less UE power to that more nearby gNB by lowering UE transmit power's, better MCS etc.

However, the above can be problematic because this enables an adversary (using simple UE/wireless monitoring Apps/(e.g. IoT) device in the area) to collect this cell sleep mode change information, and potentially (forward it to bad actor(s)/adversaries even in other locations) so that it can be inferred that UEs (see further safety/privacy example below) are (likely) now arriving to that location. (Referred to here as a “monitoring UE location” or “remote monitoring UE location”).

### Security/Safety/Privacy Related Examples

Adversaries even in other locations can infer that public safety UEs are (likely) now arriving to that location:

In one non-limiting example, if the arriving UEs in the above example arriving are public safety/police UEs, it may be that this will prevent the police from being able to “silently” arrive without giving the “suspects” at that location advance notice.

Adversaries even in other locations can infer that victim UE(s) is/are (likely) now arriving to (or departing) that location (already associated with that UE or UEs e.g. their home):

In one non-limiting example, case where the UE(s) associated with that location arriving is a stalking victim, ex-partner/spouse, domestic violence victim, child in custody dispute, or . . . with a protection order etc. and an adversary/“bad actor”/abuser/etc. may exploit this information to “stalk/monitor” the coming and goings of that person or persons.

In another non-limiting example, this may enable someone monitor, without “lawful authorization”, e.g. the coming and goings (or possibly even a motorcade/caravan route) of a person or persons such as government officials, military personnel, etc.

These stalking like examples may be further enabled by combining (e.g. AIML training of) this monitoring info with e.g. social media, information.

Advertising (or tracking companies that sell tracking information to e.g. advertisers) entities, even in other locations, can infer that victim UE(s) is/are (likely) now arriving to (or departing) that location (already associated with that UE or UEs e.g. their home):

In another non-limiting example, case, this may enable some targeted advertising to be done to that end subscribers in the area by leveraging the knowledge about those subscribers activity, where those subscribers have rather limited ability to avoid that monitoring by advertisers.

Also in the above similar problems exist in “departure” scenarios where network can potentially leak information about the time of departure of a UE or UEs (e.g. from a location associated with that UE or UEs such as their home).

The above problem cases are yet more problematic when cell sleep mode is narrowed to smaller location with e.g. CSM (cell sleep mode) sleeping/stopping transmitting on a particular SSB/beam/in a particular direction.

This is potentially yet more problematic because it potentially leaks even more geographically specific information as the coverage area of the beam is generally smaller than the coverage area of the cell.

Additionally, the current system may additionally leak information on the direction (e.g. North/South/East/West) and even route of trajectory followed by a subscriber or group of subscribers where the subsequent (series) of beams/cells which are activated may provide that additional information to any entity/adversary/advertiser that is thus monitoring for implied UE locations/mobility.

Embodiments propose means to selectively control/limit/mitigate these types of attacks during cell sleep mode transitions when/where (most) needed while still enabling network and UE energy savings.

Embodiments propose enhanced privacy support during network energy saving modes. This is achieved in some embodiments by the network node selectively incorporating an intentional level of uncertainty/obfuscation in the energy saving procedures. This may be done selectively according to a privacy preference of the mobile devices. Particularly, this mode aims to inhibit data leakage related to the device location, which can be associated with cell sleep mode (CSM) transitions.

Embodiments provide equipment that is configured to generate privacy preference information that is relevant to network behaviour and to transmit this towards a network node within a 3GPP network. The information may be terminated at and utilised by the network node within the 3GPP network to control the network behaviour related for example to network energy saving policies and decisions. It may be transmitted towards the network node using RRC or MAC CE messaging. The privacy preference information may be a single bit indicating enhanced privacy is desired and/or it may comprise an indication of the level of privacy required and/or a location, time and/or activity (scope) where enhanced privacy is required. This information may be transmitted as in a number of ways, in some embodiments as UEAssistanceInformation.

The privacy preference information may be determined in response to a user input. A user interface may display a request for privacy preference for the user and the user input(s) may generate the privacy preference information. This may be generated within the user equipment, or a network node may interpret the privacy preference information and generate its own privacy preference information. The information may be transmitted towards a network node which may be the serving network node supporting radio coverage in the cell that the user equipment is within.

The user equipment may generate this privacy preference information in response to a user request or in response to circuitry within the apparatus determining a requirement for enhanced privacy.

The privacy preference information may be determined in response to a history of network energy savings observations. In another embodiment, the user equipment may indicate an elevated privacy preference on behalf of the UE at locations and/or times where at least one of: the UE is known to be associated with that location/time (e.g. home), the network is actively making energy saving decisions in response to changes in that UEs location and/or activity in the past at that location/time (e.g. at home late at night or when less background load when energy saving decision changes are more typical).

The privacy preference information may be determined based upon the UE's current location and time. In another embodiment, the user equipment may indicate an elevated privacy preference on behalf of the UE at locations and/or times where the User previously indicated via the UE user interface that the user would prefer elevated privacy, e.g. within half a mile of their home location, within half an hour of their arrival or departure time, and/or where more than a threshold number of security related incident have been previously reported (e.g. to the law enforcement).

In some embodiments, the user equipment may receive a signal from the network node prohibiting it from transmitting privacy preference information and in this case, the user equipment may generate the information but it will not be transmitted until it determines that the prohibition has expired.

The apparatus to which this privacy preference information is transmitted is a network node within a communication network. It may be a coverage cell or it may be a capacity cell network node.

The network node may modify its behaviour in response to an indication indicating a preference for enhanced privacy of the user. The behaviour it will modify is behaviour that may cause leakage of information regarding the location of the user equipment to a third party. This behaviour may include energy saving behaviour where a cell is activated or deactivated or where portions of the cell such as a carrier or beam within the cell is activated or deactivated. The modification of the behaviour may include a time delay for that behaviour to occur or may include not doing a behaviour (behaviour not occurring at all). The network node may store the privacy preference information for the user equipment within a data store. Where the privacy preference information indicates a time, location and/or activity then the network node will modify its behaviour in response to those criteria. The network node may receive the privacy preference information directly from the user equipment itself or it may receive it from another network node (e.g. from another cell or network node which is not able to locally/fully perform the needed behaviour). In some cases, the control circuitry within the network node may determine whether the apparatus is scheduled to perform steps that might leak information regarding the user equipment and only if that is the case will it modify its behaviour. Where the network node is not going to perform those steps, then in some cases it may transmit a signal to the user equipment indicating that it does not want to receive further signals from the user equipment regarding privacy preference. This may be within a predetermined time or within a predetermined area. In this way, where such privacy preferences will not affect the behaviour of the network node it inhibits/prohibits their sending thereby reducing signalling and power consumption. In some embodiments, where such privacy preferences will require additional energy (by reducing the opportunity for energy savings) the network node inhibits/prohibits their sending from devices whose subscription and/or device type is not allowed to incur such additional energy consumption, e.g. based upon a UE subscription type, or for public safety UEs. In some cases, the indication to the user equipment may be transmitted individually to the user equipment or it may be transmitted as a signal to a (specific) group of user equipment.

FIG. 1 schematically shows how a UE may transmit UEAssistanceInformation to a serving network node once it has connected to it. This UEAssistanceInformation may include privacy preference information regarding whether or not the UE requires enhanced privacy. The privacy preference information may include different levels of privacy required, it may include times when enhanced privacy is required and/or locations where enhanced privacy is required and/or activities that it is performing where enhanced privacy may be required.

FIG. 2A shows an example of an amendment to the existing UEAssistanceInformation IE that supports user configurable privacy preference.

As shown in this non-limiting example, the UAI may be amended with a Privacy-Preference-r18 IE, wherein the Privacy-Preference-r18 may include
timeBasedPrivacy
   For example, heightened privacy level during the night time than during the day time.
locationBasedPrivacy
   For example, heightened privacy level at a location that the user does frequently visit (e.g. home), and/or location associated with that UE.

There may be different levels of privacy settings (e.g. shown as 1 to 4 in FIG. 2B), representing different intensity or graveness of the privacy requirements.

FIG. 2B shows an example of an amendment to the existing UEAssistanceInformation IE that supports user configurable privacy preference.

As shown in this non-limiting example, the UAI may be amended with a Privacy-Preference-r18 IE, wherein the Privacy-Preference-r18 may include

### timeBasedPrivacy

For example, more heightened privacy level during the night time than during the day time.

### locationBasedPrivacy

For example, more heightened privacy level at a location that the user does frequently visit.

### sensingBasedPrivacy

RF sensing may be a main feature of 6G network (Integrated sensing and communication), the user for example, may not want the network to take (and share) an RF image of him/her at high resolution (in certain contexts).

In another embodiment the UE's Privacy Preference may indicate the UE's preference with respect to the privacy of the RF Profile of the UE's associated hosting entity. In one example, the UE indicates a privacy preference with respect to limiting storage and sharing of the RF Profile of the Hosting Entity associated with the UE. The RF profile can be derived from RF fingerprinting based on radio measurements that are indicative of the radio transmission characteristics associated with the UE). In this embodiment the modified network behaviour in response to receiving this UE privacy preference includes at least one of:
Limiting/inhibiting the sharing of the RF profile of the RF hosting entity associated with that UE
limiting the duration of/inhibit the storage of the RF profile of the RF hosting entity associated with that UE

In this regard 5G features like higher frequency, higher bandwidth, and beamforming have enabled further aggressive positioning targets including wide range of accuracy from meter-level to cm-level. For example, AI/ML-based positioning schemes for NR air interface may be more effective in NLOS (non line of sight) scenarios, whereas the legacy methods (e.g., TDOA (difference time of arrival), AOA/AOD (angle of arrival/angle of departure), multi-RTT round trip time, etc) may be more applicable to positioning estimate in LOS scenarios. One promising application of AI/ML in positioning and Channel Prediction is “RF fingerprinting”, wherein RF measurements are collected and analyzed in order to map the plurality of measurement results to a positioning reference model that reflects the environment of the device. The model may be obtained through extensive RF measurements in all possible locations in the coverage area. This model may be part of the digital twin of the environment and/or for use in supervised learning.

User communication and positioning may be determined through measurements of the signals between the user equipment (UE) and a plurality of Transmit Reception Points (TRPs) of the network nodes.

However, in the “hosting entity” case where UE may be situated inside a car (e.g., in driver's pocket), or may be a part of a truck (e.g., as an IOT device), or a piece of machinery (e.g., forklift) in the factory, etc. In this case, the UE moves in the same trajectory as the entities it is associated with, and these entities are referred to herein as hosting entities for the UE. If the UE is associated with a “hosting entity”, such as a car or a truck, then the RF communication and positioning accuracy [based on the measurements of signals (e.g., RSRP (reference signal received power), ToA, LOS/NLOS, . . . ) between the UE antennas and the gNB antennas] may be degraded by the changes in the channel condition due to the hosting entity associated with the UE.

FIG. 3 shows an example of RF sensing in a wireless system with gNBs, 50A, 50B a car and a truck with UEA 10A and UEB 10B inside the respective vehicles. In this case it is the truck (also referred to as the hosting entity for UEB), not merely the UEB handset that blocks or attenuates the gNB1 signal to/from the UEA in the car. In this FIG. 3 example, the UEB 10B moves in tandem with the truck (e.g. inside, adjacent to, in front of, behind, with or without “platooning” per se). It is helpful to know the RF characteristic/profile of the entity that UEB is hosted in. As the truck moves with the UEB, the gNB1 50A, and then neighbouring gNB2 50B, can utilize the penetration loss of the truck and the size of the truck (i.e. RF profile of the truck/hosting entity of UEB 10B), to predict the NLOS (non-line of sight) (condition for the car/UE-A and take pre-emptive actions, e.g. switch to a different TRP (total radiative power) for positioning of UE_ to improve the energy efficiency and accuracy of positioning and communications with UEA and UEB.

Each Privacy Type may be individually turned on or off. It is worth noting that the above message formats are to be considered exemplary and not restrictive.

FIG. 4 shows an example wireless system that has a Coverage Cell B, two capacity cells C1 and C2, a UE, and two (collaborating) malicious devices A1 and A2 (also referred to as adversary). Cell B provides the coverage of the area and is always switched on in this example, whereas capacity cells C1 and C2 provide additional data bandwidth for mobile users but can be switched on or off based on instructions from cell B/according to UE loading. The adversary nodes A1 and A2 are “sniffers” (possibly just regular UE devices) that operate in promiscuous mode and are able to monitor, capture and analyze the RF/overhead/etc. (cell ID) availability of C1 and C2 to derive sensitive information pertaining to victim UE, potentially with the help of AI/ML.

As shown in FIG. 4, the victim UE travels along a path (dashed arrow) from the coverage area of C1 to the coverage area of C2. Initially C1 is switched on to provide extra data capacity to the UE and C2 is switched off for energy saving. As the UE moves away from C1 and approaches C2, cell B may send energy saving commands to switch off C1 and switch on C2. In the meantime, adversaries A1 and A2 may detect the cell power switch on/off events at C1 and C2 through their own measurements, and thus may be able to associate the victim UE with each gNB cell location.

Embodiments propose that an intentional uncertainty may be incorporated into the switching on/off event sequence in C1 and C2, for example, switch on C2 early by an arbitrary period of time or switch off C1 late by an arbitrary period of time, such that the adversaries can not (as) closely associate the C1 and/or C2 signalling changes with the movements of the privacy sensitive/victim UE(s). Clearly, introducing small uncertainties may lessen the effectiveness of energy saving some, but this may be justified as needed in certain scenario (and might even e.g. recouped by a premium service through which a UE (or groups of UEs) may subscribe to request enhanced privacy protection).

The signalling flow of embodiments is shown in FIG. 5. Initially the UE transmits a privacy preference report towards a coverage cell indicating whether it requires enhanced privacy and in some cases a level of enhanced privacy and a time/location/activity where this is required. The coverage cell makes provision for privacy preferences in energy saving decisions in response to receipt of the report and then transmits the energy saving procedures with built in uncertainty where enhanced privacy is required to the capacity cell.

As shown in FIG. 4, in a coverage area, the coverage cell is kept switched-on and is always available for the UE, whereas one or more capacity cells can be switched off to provide energy savings but can also be switched on to provide additional capacity for the UE.

Embodiments proposes that the UE may send a PrivacyPreference Report message to the coverage (or other) cell to indicate the UE's preference for the privacy protection in the event of an energy saving procedure.

With the privacy preference from the UE, the coverage cell may take certain measures to dis-associate the power saving steps in the capacity cells according to the privacy preference in the UE's presence, e.g. by adding a certain level of uncertainty, which may include, but not limited to:
Add a random time period (e.g., use a random variable) such that the power on time of the capacity cell (beam or beams) may start early (or late) by a non-deterministic period of time before the “true” switch on time.
Add a random time period (e.g., use a random variable) such that capacity cell switches off late (or early) by a non-deterministic period after the “true” switch off time.
Randomly switch on or off a capacity cell (beam or beams) for a non-deterministic time period to “fool” the adversary from “learning”.
Aggregate/Lump more UEs in the energy saving procedure such that it is harder for the adversary to associate the CSM (cell sleep mode) power on/off with one particular CSM privacy sensitive UE out of a group of UEs.
Do not use energy saving procedure for this UE.

The privacy preference from the UE may be conveyed in the UE Assistance Information (UAI) and use the UAI signalling framework.

FIG. 6 shows a user equipment 10 and network node 50 according to an embodiment. User equipment 10 comprises generating circuitry 20 configured to generate privacy preferences relevant to network behaviour for the apparatus. It also comprises a transmitter 40 for transmitting this information. The user equipment 10 further comprises a user interface 30 comprising display 31 for displaying questions regarding user privacy preferences to a user and an input device 32 for the user to respond to these questions and input their preferences. The generating circuitry 20 will generate the privacy preference information in response to these inputs. The user equipment 10 may further comprise determining circuitry 25 for determining if there is an enhanced requirement for privacy and it may be in response to this that the privacy preference questions are displayed to the user by display 31.

User equipment 10 also has receiving circuitry 42 for receiving signals from the network node and these signals may include a signal indicating that the transmission of privacy preference information is currently prohibited in which case the user equipment will not transmit that information and in some cases will not generate it.

In this embodiment, user equipment 10 is within the cell of network node 50. Network node 50 comprises control circuitry 52 that is configured in response to the network node receiving privacy preference information from the user equipment to control the network node 50 to modify its behaviour. In this embodiment, network node 50 comprises energy saving circuitry 60 that is configured to reduce the energy consumption of the network node by deactivating or activating the node and in some cases by deactivating or activating portions of the node. In this embodiment control circuitry 52 is configured in response to the network node receiving at receiving circuitry 70 privacy preference information either from the user equipment 10 or from another network node to control the energy saving circuitry 60 to modify the energy saving behaviour of the network node so as to inhibit the leakage of information regarding the user equipment's location 10. In this regard, the privacy preference information may indicate a time period during which such modified behaviour should occur and/or may specify a location and/or an activity to the user equipment that might trigger this behaviour. The network node 50 comprises a data store 72 for storing the privacy preference information that it receives.

In some embodiments, network node 50 comprises determining circuitry 64 configured to determine whether the network is likely to exhibit energy saving behaviour, perhaps the cell is very busy and unlikely to deactivate any part of it for some time. Where the determining circuitry determines that it is not likely to exhibit energy saving behaviour any time soon, the network node 50 may in some embodiments transmit an indication to the user equipment using transmitting circuitry 74 not to transmit privacy preference information in the near future or within a predetermined time period. In response to receipt of this information the user equipment 10 may not transmit privacy preference information for the predetermined time period.

Alternatively and/or additionally the determining circuitry 25 of user equipment 50 may be configured to determine whether the network is likely to exhibit energy saving behaviour, perhaps from the cell history and/or latency as observed by one or more UEs indicating the cell is likely to be very busy and unlikely to deactivate any part of it for some time. Where the determining circuitry 25 determines this to be case, the user equipment 50 may in some embodiments choose not to transmit privacy preference information for some time or within a predetermined time period.

FIG. 7 shows a flow diagram illustrating steps performed at a user equipment for a method according to an embodiment. In step D5 user equipment determines if there is a requirement for enhanced privacy or not. This is an optional step and may not occur. If it determines that there is no requirement it will continue to monitor to see when there is a requirement. If it determines that there is a requirement then it will at step S10 display a request for user privacy preferences. It will receive these user privacy preferences at step S20 and will then determine at step D25 whether a signal has been received prohibiting transmission of privacy preference information from the network. If it has not then it will proceed to step S30 where it will generate privacy preference information and at step S40 it will transmit this privacy preference information towards the network. It should be noted that D25 may be performed between step S30 and between S40. If a signal has been received prohibiting a transmission of privacy preference information then the user equipment will determine if this signal is still valid and only when it determines that it is no longer valid will it proceed to S30 at step D35.

FIG. 8 shows a flow diagram illustrating example steps that may be performed at a network node. At an initial step D55 the network determines whether a signal indicative of privacy preferences of a user equipment has been received. If it has at step D65 it determines whether the network node is scheduled to perform steps that may leak information. If it is then at step S80 it will modify its behaviour within the time, location and/or during activities that are specified in the privacy preferences. If it is not scheduled to perform steps that may leak information then in some embodiments at step S70 it may transmit a signal prohibiting transmission of privacy preferences to the user equipment.

In summary embodiments may include the following aspects:

UE assistance information conveys to gNB the level of need for privacy associated with a particular cell/location/time/context which should not be compromised by CSM transitions.

This may include any combination of the following:
a) New messaging/profile whereby a UE can request that it's data activity/arrival does not (principally) trigger the network to exit (or enter a cell sleep mode)
b) UE Assistance/configuration can indicate:
   i) Relative Priority of CSM Privacy vs UE Energy Savings (and Wireless Performance) (Which one is more important)
   ii) Relative Priority of CSM Privacy vs gNB Energy Savings (and Wireless Performance) (Which one is more important)
   iii) Relative Priority of CSM Privacy vs Energy Savings (and Wireless Performance) at specific location(s), time(s), or other context(s)
   iv) Relative Priority of CSM Privacy vs Energy Savings (and Wireless Performance) in the case of an elevated emergency level or event. E.g. if there is a ETWS (earthquake and tsunami warning system) or 911 call, then
c) Multiple levels (e.g. more than 2) of the above relative priority may be appropriate, because more (complete) privacy may not be possible unless (significant) additional energy is expended.
   i) As a result, in order to provide the appropriate compromise between those competing goals, multiple levels are provided.
d) UE assistance/configuration may additionally (in one or more of the above contexts) to yield:
   i) CSM Privacy ON—de-associate CSM transition times from the UE's(or UEs') arrival/activity (e.g. modifying autonomous cell sleep mode adjustments so as to camouflage/provide the requested privacy in the context)
(1) e.g. this could be dynamically selected based on UE specific cases,
   (i) per location/geo-fencing, UE type, UE activity (see below) etc.
   (ii) Additionally, the context for the above request may further include where the request is generated by
      1. Privileged UEs, e.g. public safety UEs
      2. UE placing a 911 call
      3. UE under ETWS alert
      4. PSAP (public safety access point), which e.g. services
      5. E.g. need to enable/disable cell sleep mode privacy setting in an area
      6. e.g. if there is a silent alarm, or someone trying to surreptitiously call 911, then the dispatcher may not allow exiting out of cell sleep mode
ii) CSM Privacy OFF (e.g. enabling autonomous cell sleep mode adjustments)
   (1) e.g. this could be dynamically sent by the UE specific cases, locations, geo-fencing, UE type, etc ..
e) New messaging/profile whereby a UE can request that RF Profile of the UE's associated hosting entity) not shared with other (groups) Network Nodes and/or UE(s).
f) New messaging/profile whereby a UE can request that RF Profile of the UE's associated hosting entity) not stored beyond a certain time.

At gNB, in response to one or more received privacy information(s) (UAI/relative priority of CSM privacy vs energy savings (and/or Wireless Performance)), determining if cell sleep mode is utilized in/for that particular context

The usage of the information at the gNB could include one or more actions as below:
a) The gNB could react/accommodate the UE's/UEs request if the cell/beam is only used by the single user or a very few users.
b) the gNB utilizes modified autonomous cell sleep mode adjustments so as to camouflage/obfuscate/dis-associate energy saving procedures with UE location discovery in order to provide the requested level of CSM privacy (priority) in the context
   i) e.g. entering/exiting cell sleep mode earlier/later, and at possibly at additionally randomized times
   (1) although this may result in some extra energy use, and/or some potentially less optimal wireless performance (e.g. throughput), this strategy is incrementally responsive to the degree to which sleep mode privacy is needed, and over what geographic and/or temporal span
c) this modified approach impacts
   i) decision as to when/what cell to take out of CSM
   ii) this may include additional randomization to the CSM policy
      (1) Turn on early, or late, or when not as required
      (2) In response to UE activity, select different cell(s) or additional cell(s) to return from cell sleep mode, so as to further camouflage the exact location of the subscriber(s) activity triggering exit of cell sleep mode
   iii) Provide a new camouflage mode for the cell where the cell is only “visible” to select/trusted UEs, (this might use some cell configuration where additional cell information/capabilities/support is hidden and/or blocked, e.g.:
      (a) Avoids advertising cell is available via normal signalling (at least to non-trusted UEs), e.g. possibly including:
   (i) Operating as a closed subscriber group cell
   (ii) Using cell configuration “hiding” (SSID hiding for Wi-Fi APs)
      (b) Utilizing more limited beams to provide coverage only when/where needed, and possibly avoid allowing less trusted UEs being able to determine cell is no longer in CSM.
   (i) Avoid Tx where (and when) suspected “untrusted” (e.g. NB-IoT/RedCap monitor/possible adversary) devices are located (and are awake and monitoring/not in DTX)
   (ii) Ignoring UE Tx which are not likely trusted, e.g. which are not
   1. An already connected (victim UE) and are being HO into that cell.
   2. Not using specific preagreed PRACH,
   3. Tx from trusted location(s)
d) As a further example,
   i) In the example far above with police arriving at a particular location, it may be that they delay cells from exiting cell sleep mode until the police have announced their presence at that location, e.g. knocking on the door/serving a warrant
   ii) In the example far above with a “vulnerable person” arriving or departing home, the geo-fencing solution may delay the cell from exiting cell sleep mode until the geo-fencing solution confirms that they have arrived or departed more than some threshold time ago, or in a way which satisfy some geo-fencing requirement.
e) If in addition to (Relative Priority of CSM Privacy vs UE Energy) the UE UAI further provides (Relative Priority of CSM Privacy vs Wireless Performance) then gNB:
   (1) May use more CSM in that context so that there is more energy savings overall if CSM Privacy is most important:
      (a) Relative Priority of CSM Privacy vs UE Energy Savings is high,
      (b) (And the Relative Priority of CSM Privacy vs Wireless Performance) is high)
   (2) May use similar or smaller amount of CSM in that context, but randomize the timing of the CSM entry/exit to provide the requested level of CSM privacy if CSM Privacy is important, but Wireless performance is also a higher priority:
      (a) Relative Priority of CSM Privacy vs UE Energy Savings is high, (and the Relative Priority of CSM Privacy vs Wireless Performance) is low)
f) Where gNB may further obscure CSM exit by only allowing a cell which was in CSM to start receiving on the UL, without starting new DL Tx
g) Where gNB may further obscure CSM entry by only (initially) allowing a cell which was in CSM to start transmitting on DL on some specific beam/SSB to prevent “adversary” devices in that cell, but not in that exact beam footprint, to (immediately) discovery that CSM exit.
   (1) Per Beam CSM may have the tradeoff that if an adversary UE in that beam then more privacy information may be leaked.
   (2) However, gNB may further obscure CSM entry/exit by entering/exiting CSM on some other/random beam/SSB to further obscure the privacy information to be protected from possible “adversary” devices under those beams.
      (a) In a non-preferred embodiment gNB this may further invoke Tx on more and more channels.
h) Where gNB may further obscure CSM entry based upon the relative priority in locations where the gNB has previously observed (static e.g. IoT) devices (or with some observant App(s))—as those devices and/or Apps may be (inadvertently) enabling an adversary.

Embodiments may provide:
A new method to add an intentional uncertainty to the energy saving measures to the state of the art practices.
   The state of the art energy saving procedure is linked very strongly to a UE, which may be a privacy loophole that an adversary user may take advantage of by analyzing the pattern of the interaction between the gNB and the UE related to the power saving procedures.
   The adversary may be an eavesdropper with malicious intentions. It is may be a passive device and does not explicitly intrude the network (e.g., a hacker, a Distributed Denial of Service attack) but it still pose threat to the network and the service experience of the mobile users.
   Embodiments seek to provide a new solution to this kind of security/privacy threat via passive eavesdropping/snooping, potentially with the help of AI/ML.
A new privacy preference message from the UE to the coverage cell is introduced in embodiments.
   Several aspects of the privacy (related to time, location and sensing) are proposed with different privacy level setting.
   It may be a part of the UEAssistanceInformation and leverage the existing signaling framework.

### Benefits

Better privacy protection in the energy saving procedures, i.e., to make it harder for an adversary device to deduce the prioritized privacy info of the mobile user through randomizing the association between the UE behaviour and the energy saving procedure.
Leverage existing UEAssistanceInformation frame work.
The method (i.e., add uncertainty to energy saving procedures) as proposed in embodiments is not only limited to cell switch on/off (i.e. power domain), it is applicable to a broad range of energy saving measures that are user specific, which results in change in the user behavior in time domain (e.g., DRX, DTX), frequency domain (e.g., change of carriers/BWP), and spatial domain (e.g., change in beamwidth, number of layers).

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods. The tern non-transitory as used herein, is a limitation of the medium itself (i.e., tangible, not a signal) as opposed to a limitation on data storage persistency (e.g. RAM vs ROM).

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus comprising:
generating circuitry configured to generate privacy preference information relevant to network behaviour for said apparatus; and
a transmitter configured to transmit said privacy preference information towards a network node within a communication network.

2. An apparatus according to claim 1, wherein said privacy preference information comprises a plurality of privacy preferences, at least one of said plurality of preferences being relative to at least one of the following: activity of said apparatus; location of said apparatus; or time.

3. An apparatus according to claim 2, wherein said privacy preference information comprises a privacy preference relative to location discovery of said apparatus.

4. An apparatus according to claim 1, wherein said apparatus comprises a user equipment and said user equipment is configured to generate and transmit said privacy preference information as part of UEAssistanceInformation.

5. An apparatus according to claim 1, wherein the privacy preference information indicates a level of privacy, and wherein the apparatus is configured to select the level of privacy amongst a plurality of privacy levels.

6. An apparatus according to claim 1, wherein the transmitter is configured to transmit the privacy preference information to a coverage cell managing energy saving of at least one capacity cell within a coverage area of the coverage cell.

7. An apparatus according to claim 1, wherein said privacy preference information indicates preference for privacy protection in an event of an energy saving procedure.

8. An apparatus according to claim 1, wherein said apparatus
further comprises determining circuitry configured to determine a requirement for enhanced privacy; and
said generating circuitry and said transmitter are configured to generate and transmit said privacy preference information in response to said determining circuitry determining said requirement for enhanced privacy.

9. An apparatus comprising:
control circuitry configured to:
receive, from a user equipment, privacy preference information indicating a preference for enhanced privacy of the user equipment; and
modify a network energy saving policy of said apparatus on the basis of the privacy preference information.

10. An apparatus according to claim 9, wherein said apparatus comprises energy saving circuitry configured to control said apparatus to reduce energy consumption by performing energy saving behaviour, said control circuitry being responsive to receipt of said privacy preference information indicating said preference for enhanced privacy of said user equipment to control said energy saving circuitry to dis-associate power-saving steps in capacity cells from a location of the user equipment.

11. (canceled)

12. An apparatus according to claim 9, wherein said privacy preference information comprises an indication of a time during which enhanced privacy of said user equipment is required, said control circuitry being configured to modify said energy saving policy of said apparatus with respect to said user equipment during said time indicated, and not to modify said energy saving policy with respect to said user equipment during other time.

13. An apparatus according to claim 9, wherein said privacy preference information comprises an indication of at least one activity of said user equipment which when performed does not require enhanced privacy, said control circuitry being configured to modify said behaviour of said apparatus with respect to said user equipment when said activity is not performed and not to modify said behaviour when said activity is performed.

14-18. (canceled)

19. A method comprising:
generating, by a user equipment, privacy preference relevant to network behaviour information for the user equipment; and
transmitting, by the user equipment, said privacy preference information towards a network node within a communication network.

20. The method according to claim 19, wherein said privacy preference information comprises a plurality of privacy preferences, at least one of said plurality of preferences being relative to at least one of the following: activity of said user equipment; location of said user equipment; or time.

21. The method according to claim 20, wherein said privacy preference information comprises a privacy preference relative to location discovery of said user equipment.

22. The method according to claim 19, wherein said user equipment generates and transmits said privacy preference information as part of UEAssistanceInformation.

23. The method according to claim 19, wherein the privacy preference information indicates a level of privacy, and wherein the user equipment selects the level of privacy amongst a plurality of privacy levels.

24. The method according to claim 19, wherein the user equipment transmits the privacy preference information to a coverage cell managing energy saving of at least one capacity cell within a coverage area of the coverage cell.

25. The method according to claim 19, wherein said privacy preference information indicates preference for privacy protection in an event of an energy saving procedure.

26. The method according to claim 19, wherein said user equipment:
determines a requirement for enhanced privacy; and
generates and transmits said privacy preference information in response to said determining said requirement for enhanced privacy.

27-36. (canceled)
